(19) United States
(12) Patent Application Publication
(10) Pub. No.: US 2007/0063858 A1
(43) Pub. Date: Mar. 22, 2007

(54) Multi-function wireless detecting device

(76) Inventors: Tzong-Sheng Lee, Chunan Town (TW); Yen-Chun Wang, Hsinchu City (TW); Jeng-Long Ou, Chutung Town (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/229,589

(22) Filed: Sep. 20, 2005

(51) Int. Cl. G08B 17/10

(52) U.S. Cl. 340/632

(57) ABSTRACT

A multi-function wireless detecting device is described. The multi-function wireless detecting device includes a monitoring pen and a wireless detector module to be carried conveniently and controlled easily. The wireless detector module includes at least one environmental parameter detector, and the monitoring pen utilizes wireless technology to control the wireless detector module and displays the data measured by the wireless detector module. The environmental parameter detector preferably includes a temperature detector and a gas concentration detector disposed on both sides of a baseboard of the wireless detector module. The gas concentration detector further includes an alcohol concentration detector, a CO concentration detector, a CO₂ concentration detector, a fuel gas concentration detector, or a combination thereof. The environmental parameter detector may further include a humidity detector.

### FIELD OF THE INVENTION

This invention generally relates to a multi-function wireless detecting device, and particularly to a multi-function wireless detecting device having a monitoring pen.

### BACKGROUND OF THE INVENTION

As technology has progressed, living has become increasingly more convenient. However, with convenient living comes environmental crises. For example, though the utilization of fuel gas has enabled convenient cooking and heating, it has also caused many cases of CO poisoning and asphyxiation since the gas was discovered.

Along with increasing advances in manufacturing precision comes increasingly more dangerous gases and dangerous genes in work sites. Thus, it is desired to effectively monitor the concentration of toxic gases like CO and CO₂ and inform workers in their work site for avoiding permanent injury due to gas asphyxiation.

It may be necessary to effectively monitor an environment during daily living or working, such as at a specific work site or residential house. For example, temperature and humidity control can increase the comfort of daily living and working, and CO and fuel gas concentration control can increase the safety of the living environment and work site.

However, a detecting device with an excessive volume is not suitable for personal or domestic use. Furthermore it is not portable. Therefore, it is desired to provide an easily-operated and portable detector for personal and domestic use to increase living and working comfort and safety.

### SUMMARY OF THE INVENTION

One object of the present invention is to provide a multi-function wireless detecting device having a pen-shaped monitoring device that is portable and ready to monitor.

Another object of the present invention is to provide a multi-function wireless detecting device which simultaneously receives a measured value from a wireless detecting module thereof for preventing a user from having to approach a monitored area for obtaining the measuring data, which not only enables the user to still measure and monitor various parameters, but also increases the operation safety for the user.

To achieve the above objects, the present invention provides a multi-function wireless detecting device comprising a pen-shaped monitoring device and at least one wireless detecting module, which is not only portable, but also readily controlled. The wireless detecting module is assembled with at least one environmental parameter detector for measuring environmental parameters. The monitoring pen utilizes wireless transmission to control and monitor the wireless detecting module and display the measured value measured by the wireless detecting module.

The wireless detecting module further comprises a baseboard, a battery and a control circuit. The environmental parameter detector is fixed on the baseboard. The battery provides power required by the environmental parameter detector. The control circuit controls the environmental parameter detector and transmits measured values to the monitoring pen. Preferably, an RF antenna is printed on the baseboard to transmit the measured value to the monitoring pen and receive the control signals from the monitoring pen.

The wireless detecting module further comprises a casing and a cover. The casing is defined with an opening aligning to the environmental parameter detector for enabling the environmental parameter detector to measure. The cover is sealed onto the casing for protecting inner components of the wireless detecting module. The baseboard utilizes a plurality of engaging members to engage with the casing for stably fixing the baseboard within the casing. The cover has a groove similar to a coin edge to facilitate locking and releasing the cover by turning it with a coin.

The environmental parameter detector includes a temperature detector and a gas concentration detector respectively on opposite surfaces of the baseboard. The gas concentration detector is preferably selected from a group consisting of an alcohol concentration detector, a CO concentration detector, a CO₂ concentration detector, a fuel gas concentration detector and combinations thereof. The environmental parameter detector preferably includes a humidity detector.

The monitoring pen includes a control circuit board, a control button and an LCD panel. The control button is assembled on the control circuit board for operating the wireless detecting module and selecting functions. The LCD panel displays the environmental parameters from the wireless detecting module and function options.

The monitoring pen is preferably printed with an antenna on the control circuit board or utilizes a pen clip antenna which is electrically coupled to the control circuit board and exposed to the monitoring pen for having functions of a pen clip and an antenna.

The monitoring pen further includes an illumination device, a battery and a sound alarm device, and further utilizes a power connector for connecting an external power supply. The wireless detecting module utilizes an external antenna connector and an external power connector for enhancing signal receiving and emitting capability and further extending operating duration.

Thus, the multi-function wireless detecting device of the present invention can conveniently and quickly measure various environmental parameters. The pen-shaped monitoring device is not only portable but also readily controlled. The monitoring pen cooperates with the wireless detecting module for providing flexibility and convenience to environmental parameter measuring and monitoring and is thereby widely applicable to environment monitoring, which not only increases living safety but also effectively increases safety of work sites.

These and other embodiments, aspects and features of the invention will be better understood from a detailed description of the preferred embodiments of the invention, which are further described below in conjunction with the accompanying figures.

### BRIEF DESCRIPTION OF THE DRAWINGS

FIG. 1A is a side view of an embodiment of a wireless detecting module of a multi-function wireless detecting device in accordance with the present invention;

FIG. 1B is a side view of another embodiment of a wireless detecting module of a multi-function wireless detecting device in accordance with the present invention;

FIG. 2A is a top view of FIG. 1B, showing a configuration of an upper surface of the baseboard;

FIG. 2B is a bottom view of FIG. 1B, showing a configuration of a lower surface of the baseboard;

FIG. 3A shows a preferred fixing manner of the wireless detecting module of the multi-function wireless detecting device;

FIG. 3B shows another preferred fixing manner of the wireless detecting module of the multi-function wireless detecting device;

FIG. 3C shows a further preferred fixing manner of the wireless detecting module of the multi-function wireless detecting device;

FIG. 3D shows a further preferred fixing manner of the wireless detecting module of the multi-function wireless detecting device;

FIG. 4A is a schematic view of an embodiment of a monitoring pen of the multi-function wireless detecting device in accordance with the present invention; and

FIG. 4B is a schematic view of another embodiment of a monitoring pen of the multi-function wireless detecting device in accordance with the present invention.

### DETAILED DESCRIPTION OF THE PREFERRED EMBODIMENTS

The multi-function wireless detecting device of the present invention is not only portable for measuring desired phenomena at any moment but also mountable with various environmental parameter detectors on a wireless detecting module thereof for increasing the portability and practicality of the multi-function wireless detecting device and thereby increasing the safety and comfort of a living environment. The following description is of the best presently contemplated mode of carrying out the present invention. This description is not to be taken in a limiting sense but is made merely for the purpose of describing the general principles of the invention. The scope of the invention should be determined by referencing the appended claims.

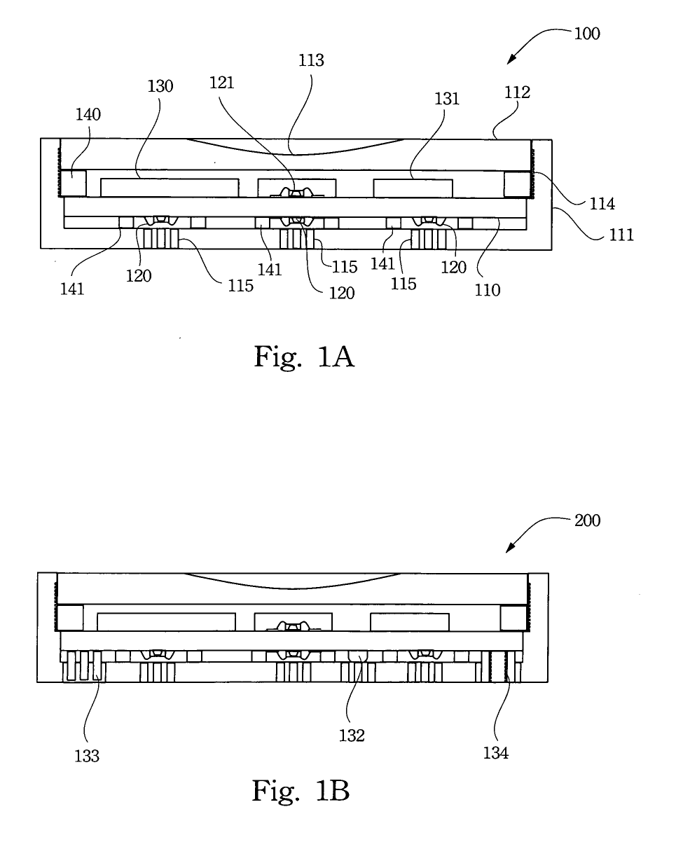

FIG. 1A shows a side view of an embodiment of a wireless detecting module of a multi-function wireless detecting device in accordance with the present invention. The wireless detecting module 100 includes a baseboard 110, a detector 120, a control circuit 131 and a battery 130. The baseboard 110 is preferably printed with an RF antenna. A surface of the baseboard 110 is disposed with various detectors 120 which may be preferably various environmental parameter detectors such as a temperature detector, a humidity detector, and CO, CO₂ or fuel gas concentration detectors.

The baseboard 110 is installed in a flat casing 111 such as a plastic box. A plurality of apertures 115 is defined in the bottom of the casing 111 for providing access to the various detectors 120 for various data gathering. Preferably, O-shaped rings are disposed between the various detectors 120 for separating them from each other. The temperature detector 121 may be disposed on another surface of the baseboard 110 to measure environmental temperature. To enable users to replace the battery 130, the flat casing 111 is further disposed with a cover 112, such as a plastic cover, which can be opened with a coin. The cover 112 is defined with an opening groove 113 which has a recess similar to a coin edge for readily using a coin to open the cover 112.

The periphery of the baseboard 110 is further disposed with an O-shaped ring 140. After the cover 112 is screwed along the screw 114, the cover 112 effectively seals the control circuit 131 and the battery 130 within the baseboard 110.

FIG. 1B shows a side view of another embodiment of a wireless detecting module of a multi-function wireless detecting device in accordance with the present invention. Besides including all the features of the wireless detecting module 100 as shown in FIG. 1A, the wireless detecting module 200 further includes an LED 132, a power connector 133 and an external antenna connector 134. The LED 132 may increase the convenience of use, for example, by displaying the working status of the wireless detecting module 200 so as to let users know if the wireless detecting module 200 is working normally or if the battery needs to be replaced.

The power connector 133 provides the wireless detecting module 200 with an external power supply for increasing the operating duration of the wireless detecting module 200. Furthermore, an external antenna connector 134 is disposed in the wireless detecting module 200 for increasing the signal transmission capability of the wireless detecting module 200 whereby data from the multi-function wireless detecting device of the present invention can be effectively transmitted over a long distance.

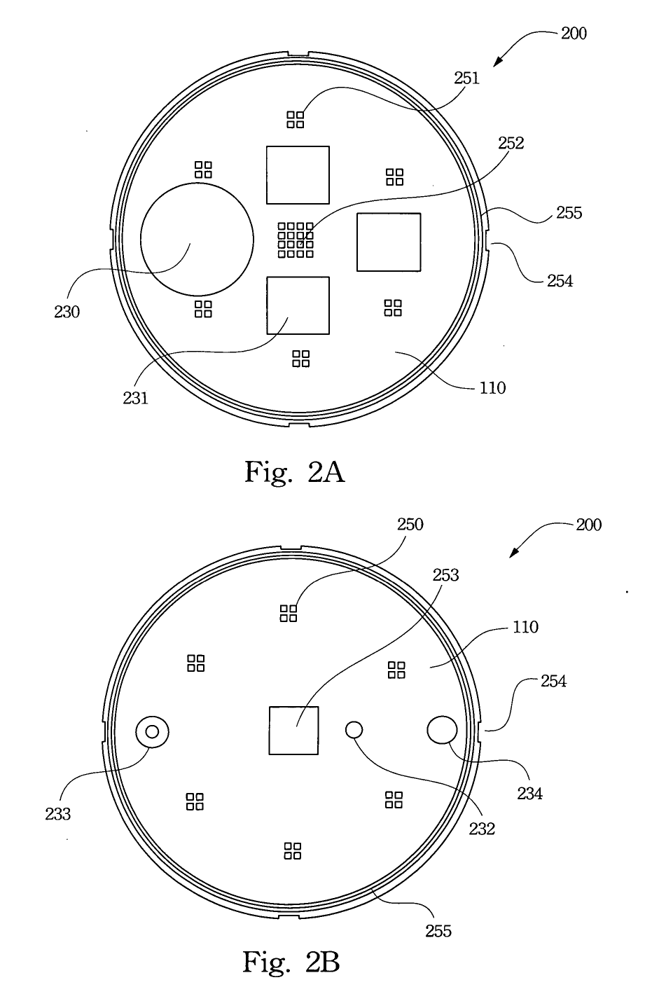

FIGS. 2A and 2B show top and bottom views of another embodiment of the wireless detecting module of the multi-function wireless detecting device in accordance with the present invention for illustrating configurations of upper and lower surfaces of the baseboard. The upper surface of the baseboard 110 is disposed with various detectors 250 at relative positions 251 thereof which are arranged in a hexagon or other shape in accordance with the number of the desired detectors 250. The temperature detector 252 is preferably disposed at the center of the baseboard 110. The baseboard 110 is further printed with an RF antenna 255 and assembled with a battery 230 and a control circuit 231. The external flange of the baseboard 110 is coupled to the casing 111 through a plurality of engaging members 254 formed therein.

The lower surface of the baseboard 110 of the wireless detecting module 200 is disposed with various environmental parameter detectors 250; for example, arranged in a hexagon and so having six positions in total. A thermally conductive printed copper foil 253 is disposed on the lower surface of the baseboard 110 corresponding to the temperature detector 252 at the center of the baseboard 110 for increasing the sensitivity of the temperature detector 252. Simultaneously, the lower surface of the baseboard 110 is configured with a printed RF antenna 255 for increasing the signal emitting and receiving capability.

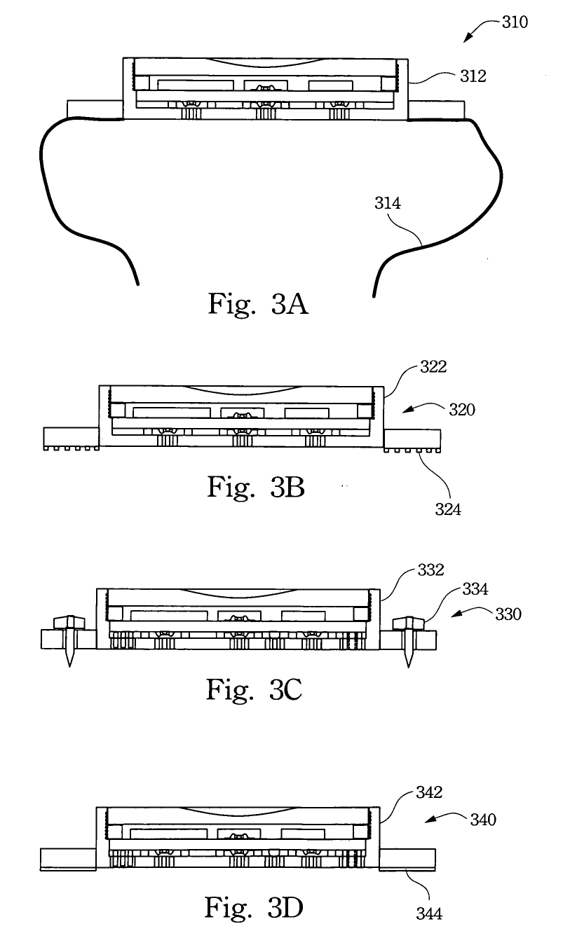

FIGS. 3A-3D show various fixing manners of the wireless detecting module of the multi-function wireless detecting device of the present invention. As shown in FIG. 3A, the wireless detecting module 310 utilizes a fixing strip 314, such as, for example, a wrist strap or an arm band, to fix a module body 312 to any place which needs measuring of environmental parameters. For example, a person working in a dangerous work area can conveniently take the wireless detecting module 310 to monitor peripheral environmental parameters. When the environmental parameters have unexpected variations, the worker can be reminded in real time to leave the dangerous work area, thereby effectively increasing worker safety.

As shown in FIG. 3B, the wireless detecting module 320 utilizes a Velcro strap 324 to fix a module body 322 to a desired position, for example on clothing or furniture, which is convenient to repeatedly change positions. As shown in FIG. 3C, the wireless detecting module 330 utilizes a fixing module 334, such as nails or bolts, to stably fix a module body 332 to a desired position. As shown in FIG. 3D, the wireless detecting module 340 utilizes adhesive material, such as glue 344, to fix the module body 342 to a desired position.

Therefore, the wireless detecting module of the present invention can be easily fixed to any position requiring measuring environmental parameters, thereby making the measuring convenient and easy.

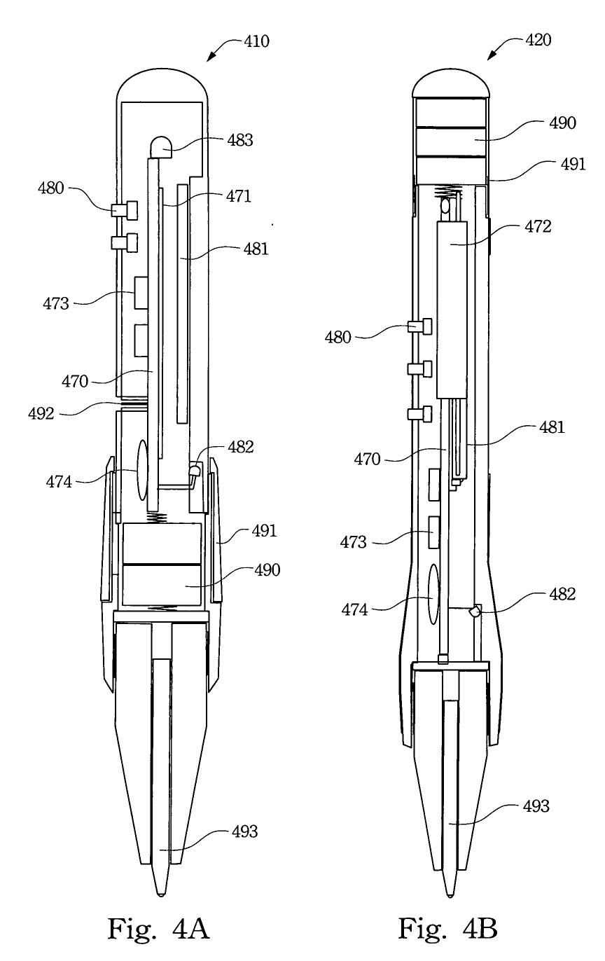

The present invention further utilizes a monitoring pen to receive measuring data. FIG. 4A illustrates a schematic view of an embodiment of a monitoring pen of the multi-function wireless detecting device in accordance with the present invention. The monitoring pen 410 includes a control circuit board 470, a control button 480, an LCD panel 481 and a battery 490.

The control circuit board 470 locates in a pen body of the monitoring pen 410 and is configured with a printed antenna 471. The control circuit board 470 further includes a control circuit 473 and a sound alarm device 474. The LCD panel 481 can display various measuring data, control parameters and status, and various function options. The monitoring pen 410 further includes a pen core 493 at a front end thereof for writing.

The control button 480 on the pen body is for operating various functions and controlling the wireless detecting module. The pen body may be assembled with an LED 482 for indication or illumination. An illumination lamp-house 483 is additionally assembled at a rear end of the pen. The monitoring pen 410 preferably utilizes a battery 490 to supply operation power and utilizes a battery chamber sleeve 491 to open the battery chamber for replacing the battery. However, the monitoring pen 410 of the present invention may be additionally connected with an external power supply or charge connector 492 for adapting to various requirements of different operations.

FIG. 4B shows a side view of another embodiment of a monitoring pen in accordance with the present invention. The monitoring pen 420 includes a control circuit board 470, a control button 480, an LCD panel 481, a battery 490 and a pen clip antenna 472. The control circuit board 470 locates in a pen body of the monitoring pen 420. The control circuit board 470 further includes a control circuit 473 and a sound alarm device 474. The pen clip antenna 472 is exposed to the monitoring pen 420 to emit and receive data to and from the wireless detecting module. The pen body of the monitoring pen 420 may be assembled with an LED 482 for indication or illumination and utilize a battery 490 assembled at a rear end of the pen to supply operation power. When it is desired to replace the battery 490, the battery chamber may be conveniently and quickly opened via a battery chamber sleeve 491.

The multi-function wireless detecting device of the present invention may be applied to monitor environmental parameters, such as temperature, humidity and gas concentration. The wireless detecting module includes the baseboard printed with the RF antenna. The lower surface of the baseboard is configured with various detectors, preferably temperature, humidity and gas concentration detectors. The gas concentration detector, for example, is a CO, CO₂ or fuel gas concentration detector. The baseboard is sealed in a flat plastic box. Each detector works through the apertures defined in the plastic box. The multi-function wireless detecting device of the present invention utilizes a miniature wireless detecting integrated module, which is not only portable, but also convenient to wear on a wrist strap or arm band or to adhere to any place requiring measuring of environmental parameters. Furthermore, the portable monitoring pen increases flexibility and convenience in use. The monitoring pen and the wireless detecting module utilize wireless transmission technology to control and transmit data. The monitoring pen may further include an alarm device, a display device and a control device whereby a user can readily know and control data measured by the wireless detecting module through the portable monitoring pen. For further increasing wireless emitting and receiving efficiency, the pen clip may be formed as a transmission antenna for wireless signal transmission.

The wireless detecting module allows a user to have a large freedom of motion; for example, when a patient carries the wireless detecting module, a doctor or nurse carrying the monitoring pen can walk around and effectively monitor essential physiological parameters of the patient. Further, at a dangerous work site, through several wireless detecting modules, a user can monitor data measured by each wireless detecting module at any moment, and when the data measured by any one of the wireless detecting modules is abnormal, each of several workers wearing a monitoring pen is notified by the alarm device, thereby increasing worker safety and knowledge.

The preferred embodiments, aspects, and features of the invention have been described in detail. It will be apparent to those skilled in the art that numerous variations, modifications, and substitutions may be made without departing from the spirit of the invention as disclosed and further claimed below.

What is claimed is:

1. A multi-function wireless detecting device at least comprising:
a wireless detecting module having at least one environmental parameter detector assembled therein for measuring at least one environmental parameter; and
a monitoring pen being pen-shaped for portability, the monitoring pen utilizing wireless transmission to control the wireless detecting module and read at least one measured value of the at least one environmental parameter from the wireless detecting module.

2. The multi-function wireless detecting device as claimed in claim 1, wherein the wireless detecting module further comprises:
a baseboard at which the at least one environmental parameter detector is fixed;
a battery electrically connecting the baseboard for supplying power to the at least one environmental parameter detector; and
a control circuit mounted on the baseboard for controlling the at least one environmental parameter detector and transmitting the measured value to the monitoring pen.

3. The multi-function wireless detecting device as claimed in claim 2, wherein the wireless detecting module further comprises an RF antenna printed on the baseboard for transmitting the measured value to the monitoring pen and receiving control signals from the monitoring pen.

4. The multi-function wireless detecting device as claimed in claim 2, wherein the wireless detecting module further comprises:
a casing defined with at least one opening aligning to the at least one environmental parameter detector for facilitating the environmental parameter detector to measure; and
a cover sealed to the casing for protecting the wireless detecting module.

5. The multi-function wireless detecting device as claimed in claim 4, wherein the baseboard further comprises an engaging member for engaging with the casing thereby fixing the baseboard in the casing.

6. The multi-function wireless detecting device as claimed in claim 4, wherein the cover further comprises an opening groove having a recess similar to a coin edge.

7. The multi-function wireless detecting device as claimed in claim 1, wherein the environmental parameter detector at least comprises a temperature detector locating on a surface of the base board.

8. The multi-function wireless detecting device as claimed in claim 7, wherein the environmental parameter detector further at least comprises a gas concentration detector locating on another surface of the baseboard.

9. The multi-function wireless detecting device as claimed in claim 8, wherein the gas concentration detector is selected from a group consisting of an alcohol concentration detector, a CO concentration detector, a CO₂ concentration detector, a fuel gas concentration detector and combinations thereof.

10. The multi-function wireless detecting device as claimed in claim 1, wherein the environmental parameter detector further comprises a humidity detector.

11. The multi-function wireless detecting device as claimed in claim 1, wherein the monitoring pen at least comprises:
a control circuit board;
a control button electrically coupled to the control circuit board for operating the wireless detecting module; and
an LCD panel for displaying the environmental parameter from the wireless detecting module and function options.

12. The multi-function wireless detecting device as claimed in claim 11, wherein the control circuit board further comprises an antenna printed thereon.

13. The multi-function wireless detecting device as claimed in claim 11, wherein the monitoring pen further comprises a pen clip antenna electrically coupled to the control circuit board and exposed to the monitoring pen for having a function of a pen clip.

14. The multi-function wireless detecting device as claimed in claim 11, wherein the monitoring pen further comprises:
an illumination device;
a battery for supplying power to the monitoring pen; and
a sound alarm device for making an alarm sound.

15. The multi-function wireless detecting device as claimed in claim 1, wherein the wireless detecting module further comprises an external antenna connector and an external power connector for enhancing capability of emitting and receiving signals.

16. The multi-function wireless detecting device as claimed in claim 1, wherein the monitoring pen further comprises a power connector for connecting with an external power supply.

17. A multi-function wireless detecting device at least comprising:
a wireless detecting module further comprising:
a baseboard;
at least one environmental parameter detector fixed on the baseboard;
a battery electrically connecting the baseboard for supplying power required by the at least one environmental parameter detector;
an RF antenna printed on the baseboard; and
a control circuit disposed on the baseboard for controlling the at least one environmental parameter detector and transmitting a measured value of the at least one environmental parameter detector through the RF antenna; and
a monitoring pen being pen-shaped for portability, the monitoring pen further comprising:
a control circuit board;
a control button electrically coupled to the control circuit board for operating the wireless detecting module;
an LCD panel for displaying the measured value transmitted from the wireless detecting module and displaying function options; and
an antenna electrically coupled to the control circuit board for receiving the measured value from the wireless detecting module and transmitting control signals to the RF antenna of the environmental parameter detector.

18. The multi-function wireless detecting device as claimed in claim 17, wherein the environmental parameter detector comprises a temperature detector on a surface of the baseboard and at least one gas concentration detector on the other surface of the baseboard.

19. The multi-function wireless detecting device as claimed in claim 18, wherein the gas concentration detector is selected from a group consisting of an alcohol concentration detector, a CO concentration detector, a CO2 concentration detector, a fuel gas concentration detector and combinations thereof.

20. The multi-function wireless detecting device as claimed in claim 17, wherein the environmental parameter detector further comprises a humidity detector.
